(19) United States
(12) Patent Application Publication
(10) Pub. No.: US 2005/0050708 A1
(43) Pub. Date: Mar. 10, 2005

(54) Embedded fastener apparatus and method for preventing particle contamination

(75) Inventors: Yu-Lien Huang, Hsin-Chu (TW); Weng Chang, Taipei (TW); Syun-Ming Jang, Hsin-Chu (TW); Mong Song Liang, Hsin-Chu (TW)

Correspondence Address: TUNG & ASSOCIATES;Suite 120, 838 W. Long Lake Road, Bloomfield Hills, MI, 48302, US

(73) Assignee: Taiwan Semiconductor Manufacturing Co., Ltd.

(21) Appl. No.: 10/656,586

(22) Filed: Sep. 4, 2003

(51) Int. Cl. B23P 11/00; B21D 39/03

(52) U.S. Cl. 29/428; 29/525.01; 118/715

(57) ABSTRACT

A novel embedded fastener apparatus and method for fastening components to the interior of a process chamber of a semiconductor fabrication apparatus. In one embodiment, an apparatus having a showerhead or gas distribution plate which is mounted to the interior of the process chamber using multiple fasteners which are embedded in respective fastener openings in the showerhead. In another embodiment, an apparatus having a showerhead which is mounted to the interior of the process chamber using multiple exterior fasteners which extend into the showerhead through the walls of the process chamber. Accordingly, the regions of the showerhead which surround the fasteners are physically separated from the interior of the process chamber.

### FIELD OF THE INVENTION

The present invention relates to apparatus for fabricating semiconductor integrated circuits on semiconductor wafer substrates. More particularly, the present invention relates to apparatus having embedded fasteners and an embedded fastener method for the fastening of components in a semiconductor fabrication apparatus.

### BACKGROUND OF THE INVENTION

Generally, the process for manufacturing integrated circuits on a silicon wafer substrate typically involves deposition of a thin dielectric or conductive film on the wafer using oxidation or any of a variety of chemical vapor deposition processes; formation of a circuit pattern on a layer of photoresist material by photolithography; placing a photoresist mask layer corresponding to the circuit pattern on the wafer; etching of the circuit pattern in the conductive layer on the wafer; and stripping of the photoresist mask layer from the wafer. Each of these steps provides abundant opportunity for organic, metal and other potential circuit-contaminating particles to accumulate on the wafer surface as well as on the interior surfaces of the process chambers in which the processes are carried out.

As an example, CVD processes include thermal deposition processes, in which a gas is reacted with the heated surface of a semiconductor wafer substrate, as well as plasma-enhanced CVD processes, in which a gas is subjected to electromagnetic energy in order to transform the gas into a more reactive plasma. Forming a plasma can lower the temperature required to deposit a layer on the wafer substrate, to increase the rate of layer deposition, or both. However, in plasma process chambers used to carry out these various CVD processes, materials such as polymers are coated onto the chamber walls and other interior chamber components and surfaces during the processes. These polymer coatings frequently generate particles which inadvertently become dislodged from the surfaces and contaminate the wafers.

In semiconductor production, the quality of the integrated circuits on the semiconductor wafer is directly correlated with the purity of the fabricating processes, which in turn depends upon the cleanliness of the manufacturing environment. Furthermore, technological advances in recent years in the increasing miniaturization of semiconductor circuits necessitate correspondingly stringent control of impurities and contaminants in the plasma process chamber. When the circuits on a wafer are submicron in size, the smallest quantity of contaminants can significantly reduce the yield of the wafers. For instance, the presence of particles during deposition or etching of thin films can cause voids, dislocations, or short-circuits which adversely affect performance and reliability of the devices constructed with the circuits.

Due to the small geometries of components in modern semiconductor integrated circuits, particles having a size larger than about 0.02 m can significantly adversely affect semiconductor processing. Current geometry sizes for semiconductor integrated circuits have reached less than half a micron, and those circuits are adversely affected by particles having a size as small as 0.01 m. In the future, semiconductor integrated circuits will be marked by increasingly smaller geometry sizes, requiring protection from contamination by correspondingly smaller particles.

Particle and film contamination has been significantly reduced in the semiconductor industry by improving the quality of clean rooms, by using automated equipment designed to handle semiconductor substrates, and by improving techniques used to clean the substrate surfaces. However, as deposit of material on the interior surfaces of the processing chamber remains a problem, various techniques for in-situ cleaning of process chambers have been developed in recent years. Cleaning gases such as nitrogen trifluoride, chlorine trifluoride, hexafluoroethane, sulfur hexafluoride and carbon tetrafluoride and mixtures thereof have been used in various cleaning applications. These gases are introduced into a process chamber at a predetermined temperature and pressure for a desirable length of time to clean the surfaces inside a process chamber. However, these cleaning techniques are not always effective in cleaning or dislodging all the film and particle contaminants coated on the chamber walls. The smallest quantity of contaminants remaining in the chamber after such cleaning processes can cause significant problems in subsequent manufacturing cycles.

A typical conventional CVD (chemical vapor deposition) system is illustrated schematically by reference numeral 10 in FIG. 1. The CVD system 10 generally includes an enclosure assembly 6, having a vertically-movable wafer support pedestal 12 disposed beneath a showerhead 30, through which process gases enter a vacuum chamber 15. A pumping plate 17 may extend around the wafer support pedestal 12 for discharging process gases and other plasma residue from the chamber 15 and into a pumping channel 14 partially circumscribing the chamber 15, as indicated by the arrows 21.

The enclosure assembly 6 is typically an integral housing constructed of a process-compatible material such as anodized aluminum. The enclosure assembly 6 includes a continuous sidewall 11 and a top 7 that includes a top opening (not illustrated) sealed by a removable lid 18. The lid 18 is typically provided with an inlet tube 16 for allowing deposition gases to enter the showerhead 30, where the gases are uniformly dispersed throughout the chamber 15 onto a wafer (not illustrated) supported on the wafer support pedestal 12. The deposition process performed in the apparatus 10 may be a thermal process, a plasma-enhanced process or other chemical vapor deposition process.

In a typical metal deposition process such as that used in the formation of a tungsten plug (not shown) in an opening formed in a dielectric layer on a wafer (not shown), deposition gases are introduced into the chamber 15 through the inlet tube 16 and the showerhead 30, respectively, where the gases are deposited into the opening (not illustrated) in the dielectric layer on the wafer. Upon completion of the CVD process, the gases are evacuated from the chamber 15 by operation of a pump (not illustrated) which induces vacuum pressure in the pumping channel 14 to draw the gases out of the chamber 15 and through the pumping channel 14, where the gases are discharged from the apparatus 10 through a discharge conduit 31 and throttle valve 32.

During the chemical deposition process, solid residues frequently form on the sidewalls 11, wafer support pedestal 12 and other interior surfaces of the chamber 15. Accordingly, regular periodic cleanings of the chamber 15 between CVD process cycles is necessary for maintaining performance of the CVD system 10 at optimum levels in the production of high-quality integrated circuit devices. Such periodic chamber cleanings are facilitated by introducing cleaning gases and chemicals into the chamber 15 through the inlet tube 16 and showerhead 30, respectively, while maintaining a vacuum in the chamber 15 by evacuating the gases through the discharge conduit 31 and throttle valve 32. While such periodic chamber cleaning cycles are effective in removing much of the residues from the interior surfaces of the CVD system 10, the residues tend to accumulate on the surfaces over time, and these must be removed using periodic preventative maintenance (PM) cleanings. In a PM cleaning, the lid 18 and showerhead 30 components of the CVD system 10 are removed and the vacuum pressure inside the chamber 15 is dispelled to facilitate manually wiping down the interior surfaces of the chamber 15 in order to remove the accumulated residues from the surfaces. Upon commencing the PM cleaning process, however, some toxic, corrosive and/or flammable residual deposition gases may remain in the chamber 15, and additional potentially harmful gases such as HF may be formed upon contact of hydrogen peroxide, a common cleaning agent, or water with the residues. These potentially harmful gases tend to escape from the open chamber 15 and into the ambient environment of the CVD system 10, where the gases may injure persons involved in the chamber-cleaning operation or other persons in the vicinity of the CVD system 10.

Particles which may contribute to contamination of substrates during semiconductor fabrication have generally two sources. As one source, the intrinsic process design parameters may contribute to excess particle production. As another source, the design of the hardware or equipment used to carry out the processing may contribute to excess particle production. Because it is difficult to modify the process parameters in a satisfactory manner to reduce excess particle production, hardware re-design or modification remains the more effective and practical method for minimizing particle production and contamination of substrates during processing.

A common characteristic of a conventional CVD system, as well as other types of semiconductor processing systems extensively used in the semiconductor fabrication industry such as PVD (physical vapor deposition) chambers, etching chambers and ashing chambers, for example, is that the showerhead on the interior of the chamber is mounted in place using screws or other fasteners which protrude beyond the interior surface of the showerhead. The region of the showerhead surrounding the fastener tends to become damaged by thermal expansion cycling or plasma arcing, and this causes the accumulation of particles in the damaged area. It has been found that mounting the showerhead in place using fasteners which are embedded in the surface of the showerhead or extend from the process chamber exterior, through the wall of the chamber and into the showerhead significantly reduces thermal cycling damage which may otherwise facilitate the accumulation of contaminating particles thereon.

Accordingly, an object of the present invention is to provide an embedded or recessed fastener technique for mounting components in a process chamber.

Another object of the present invention is to provide an embedded or recessed fastener technique which is suitable for mounting components in any type of process chamber including but not limited to a CVD, PVD, etching or ashing chamber.

Still another object of the present invention is to provide an apparatus having a showerhead or gas distribution plate which is mounted in a chamber using embedded or recessed fasteners.

Yet another object of the present invention is to provide an apparatus having a showerhead or gas distribution plate which is mounted in a chamber using exterior fasteners.

A still further object of the present invention is to provide a method for preventing or reducing particle contamination of a showerhead or gas distribution plate, which method includes fastening the showerhead or gas distribution plate to a chamber interior using multiple embedded fasteners.

Another object of the present invention is to provide a method for preventing or reducing particle contamination of a showerhead or gas distribution plate, which method includes fastening the showerhead or gas distribution plate to a chamber interior using multiple exterior fasteners.

### SUMMARY OF THE INVENTION

In accordance with these and other objects and advantages, the present invention is generally directed to a novel embedded fastener apparatus and method for fastening components to the interior of a process chamber of a semiconductor fabrication apparatus. In one embodiment, the invention includes an apparatus having a showerhead or gas distribution plate which is mounted to the interior of the process chamber using multiple fasteners which are embedded in respective fastener openings in the showerhead. In another embodiment, the invention includes an apparatus having a showerhead which is mounted to the interior of the process chamber using multiple exterior fasteners which extend into the showerhead through the walls of the process chamber. Accordingly, the regions of the showerhead which surround the fasteners are physically separated from the interior of the process chamber. Consequently, accumulation of particles inside the process chamber due to thermal-induced damage of the showerhead in the areas surrounding the fastener is eliminated or significantly reduced.

The invention further contemplates methods for reducing particle contamination of a showerhead or gas distribution plate in a process chamber. In one embodiment, the method includes providing fastener openings in the showerhead, extending fasteners such as screws through the fastener openings and into a structural member of the chamber, and embedding the fasteners in the fastener openings. In another embodiment, the method includes providing fastener openings through the chamber wall and into the showerhead and extending fasteners through the fastener openings to mount the showerhead in the chamber, with the respective fastener openings facing the exterior of the process chamber.

### BRIEF DESCRIPTION OF THE DRAWINGS

The invention will now be described, by way of example, with reference to the accompanying drawings, in which:

FIG. 1 is a schematic of a typical conventional CVD process chamber;

FIG. 2 is a schematic of a process chamber with multiple exterior fasteners mounting a showerhead in the chamber according to one embodiment of the present invention;

FIG. 3 is a top view of the process chamber of FIG. 2;

FIG. 4 is a schematic of a process chamber with multiple embedded fasteners mounting a showerhead in the chamber according to another embodiment of the present invention;

FIG. 5 is an exploded, perspective view of a showerhead assembly in accordance with the embedded-fastener embodiment of FIG. 4; and

FIG. 6 is a cross-sectional view of a portion of a showerhead, illustrating a typical shape of a fastener opening in the showerhead according to the embodiment of FIG. 4.

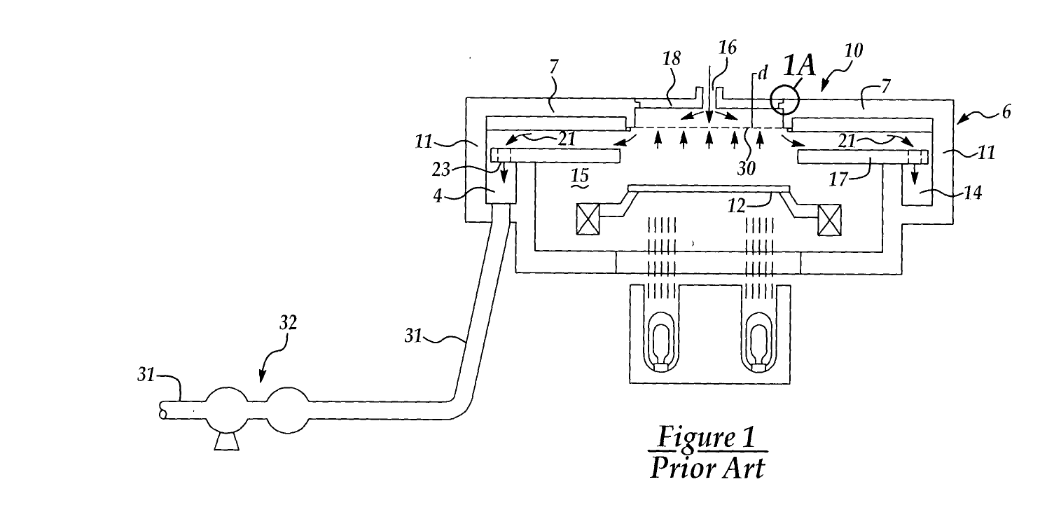

### DESCRIPTION OF THE PREFERRED EMBODIMENTS

The present invention has particularly beneficial utility in the mounting of a showerhead or gas distribution plate (GDP) in a CVD (chemical vapor deposition) chamber used to deposit material layers on a semiconductor wafer substrate. However, while references may be made to such CVD chamber, the invention may be equally applicable to mounting a showerhead or GDP in any type of process chamber such as a PVD (physical vapor deposition) chamber, an etching chamber or a plasma ashing chamber.

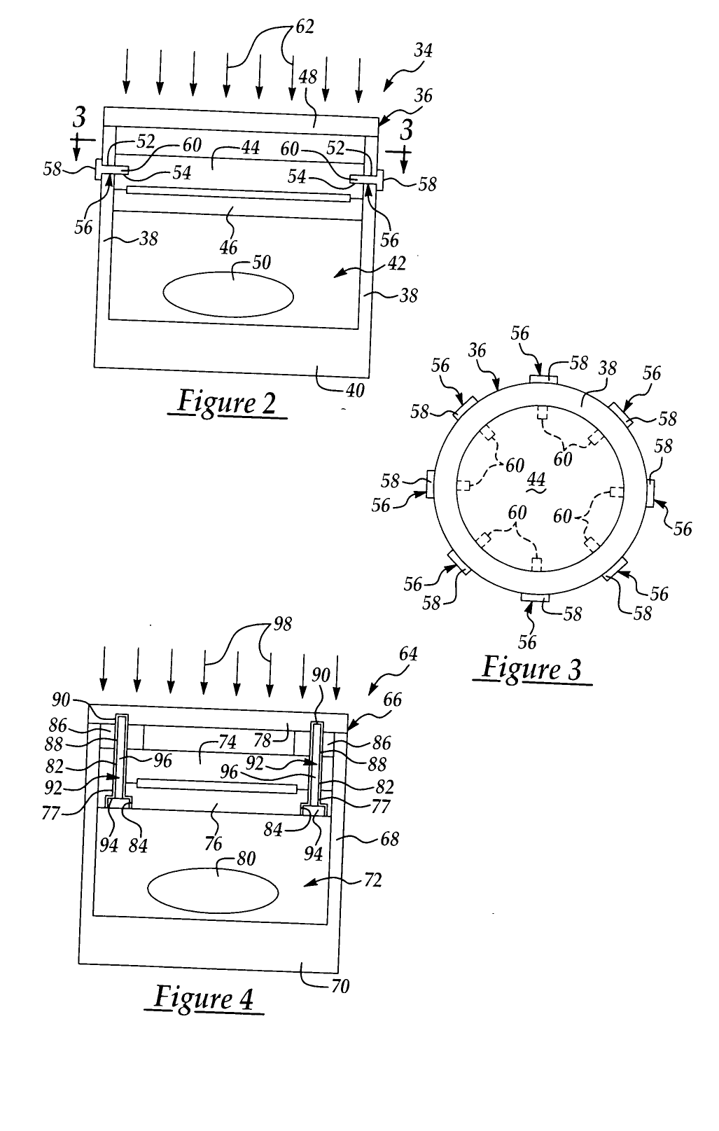

Referring to FIGS. 2 and 3, a typical CVD system 34 in implementation of one embodiment of the present invention includes a process chamber 36 having a chamber wall 38 and a chamber bottom 40 which together define a chamber interior 42. A gas mix plate 48 is typically provided in the upper end of the process chamber 36 for receiving and mixing a flow of deposition gases 62. A showerhead 44 is mounted beneath the gas mix plate 48 in a manner to be hereinafter described and receives the gas 62 from the gas mix plate 48 and disperses the gas 62 into the chamber interior 42, typically through an underlying confine ring 46, in conventional fashion. In operation of the CVD system 34, a wafer 50 is placed on a wafer support (not shown) provided in the chamber interior 42 for the deposition of material layers on the wafer 50, as is well-known by those skilled in the art. It is understood that the process chamber 36 heretofore described with respect to FIG. 2 represents one example of a process chamber which is suitable for the present invention and that process chambers of various description which may have features that depart from those heretofore described are equally suitable for implementation of the invention.

According to the present invention, the showerhead 44 is mounted in the process chamber 36 using multiple exterior fasteners 56. Each of the exterior fasteners 56 typically includes a fastener head 58 from which extends a threaded shank 60. As shown in FIG. 2, the showerhead 44 is mounted in the process chamber 36 by extending the threaded shank 60 of each exterior fastener 56 through a corresponding chamber wall fastener opening 52 which extends laterally through the chamber wall 38, and threading the threaded shank 60 into a registering showerhead fastener opening 54 which extends into the lateral surface of the showerhead 44.

As shown in FIG. 3, multiple exterior fasteners 56 are used in the manner heretofore described to mount the showerhead 44 in the process chamber 36. The exterior fasteners 56 may be equally spaced from each other along the circumference or perimeter of the chamber wall 38. In a preferred embodiment, eight of the exterior fasteners 56 are used to mount the showerhead 44, as shown, although a lesser or greater number of exterior fasteners 56 may be used, as desired.

In typical operation of the CVD system 34, deposition gases 62 are introduced into the chamber interior 42 through the gas mix plate 48, the showerhead 44 and the confinement ring 46, respectively, where the gases 62 flow into contact with the wafer 50 and materials carried by the gases 62 are deposited onto the wafer 50. Upon completion of the CVD process, the gases 62 are evacuated from the chamber interior 42 by operation of a pump (not illustrated) to draw the gases 62 out of the chamber interior 42, typically in conventional fashion.

It will be appreciated from a consideration of FIG. 2 that each showerhead fastener opening 54 in the showerhead 44 is substantially sealed off from the chamber interior 42 by abutment of the showerhead 44 against the chamber wall 38. Consequently, the exterior fasteners 56 extend into the showerhead 44 in such a manner that each of the exterior fasteners 56, as well as the regions of the showerhead 44 which contact the exterior fasteners 56, is substantially isolated from the chamber interior 42 in which processing of the wafer 50 is carried out. Accordingly, particles generated by friction between the showerhead 44 and the threaded shank 60, induced by thermal expansion and contraction cycling of the showerhead 44 during processing, are incapable of inadvertently falling into the chamber interior 42 and contaminating a wafer 50 being processed therein.

Referring next to FIGS. 4-6, a typical CVD system 64 in implementation of another embodiment of the present invention includes a process chamber 66 having a chamber wall 68 and a chamber bottom 70 which define a chamber interior 72. A gas mix plate 78 is typically mounted in the upper end of the process chamber 66, and a showerhead 74 is mounted in the process chamber 66 in a manner to be hereinafter described. A spacer 86 is typically interposed between the gas mix plate 78 and the showerhead 74. A confine ring 76 is typically mounted in the chamber interior 72, beneath the showerhead 74. In operation of the CVD system 64, a wafer 80 is placed on a wafer support (not shown) provided in the chamber interior 72 for the deposition of material layers on the wafer 80. It is understood that process chambers of various description which may have features that depart from those heretofore described with respect to FIG. 4 are equally suitable for implementation of the invention.

According to the present invention, the showerhead 74 is mounted in the process chamber 66 using multiple embedded fasteners 92. Each of the embedded fasteners 92 typically includes a fastener head 94 from which extends a threaded shank 96. As shown in FIG. 4, the showerhead 74 is mounted in the process chamber 66 by extending the threaded shank 96 of each embedded fastener 92 through a corresponding ring fastener opening 77 which extends through the confine ring 76, a showerhead fastener opening 82 which extends through the showerhead 74, a spacer fastener opening 88 which extends through the spacer 86 provided between the gas mix plate 78 and the showerhead 74. The threaded shank 96 of each embedded fastener 92 is then threaded into a registering plate fastener opening 90 which extends into the bottom surface of the gas mix plate 78. As shown in FIG. 6, the bottom end of the ring fastener opening 77 is typically characterized by a circumferential expansion which defines a fastener head cavity 84 in the confine ring 76. Accordingly, as shown in FIG. 4, the fastener head 94 of each embedded fastener 92 is contained in the corresponding fastener head cavity 84 in such a manner that the flat surface of the fastener head 94 is substantially flush with the bottom surface of the confine ring 76.

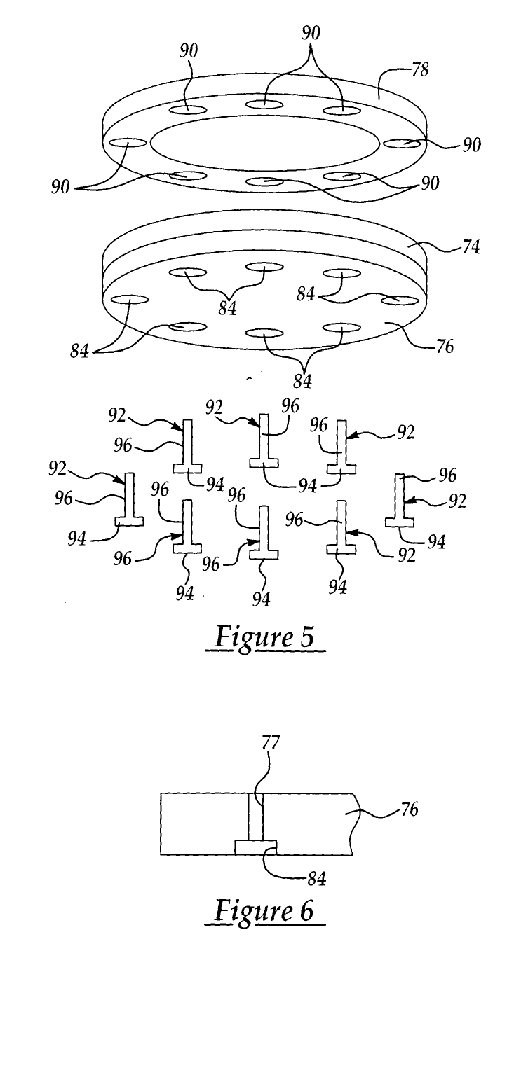

As shown in FIG. 5, multiple embedded fasteners 92 are typically used to mount the showerhead 74 in the process chamber 66. The embedded fasteners 66 may be equally spaced from each other along the circumference or perimeter of the confine ring 76 and the showerhead 74. In a preferred embodiment, eight of the embedded fasteners 92 are used to mount the showerhead 74 in the process chamber 66, as shown, although a lesser or greater number of the embedded fasteners 92 may be used, as desired.

In typical operation of the CVD system 64, deposition gases 98 are introduced into the chamber interior 72 through the gas mix plate 78, the showerhead 74 and the confinement ring 76, respectively, and flow into contact with the wafer 80. Various materials carried by the deposition gases 98 are deposited onto the wafer 80. Upon completion of the CVD process, the gases 98 are evacuated from the chamber interior 72, typically in conventional fashion.

It will be appreciated from a consideration of FIG. 4 that the fastener head 94 of each of the embedded fasteners 92 is recessed into the confine ring 76 in such a manner that the threaded shank 96 each of the embedded fasteners 92 is substantially isolated from the chamber interior 72 in which processing of the wafer 80 is carried out. Accordingly, particles generated by friction between the showerhead 74 and/or the confine ring 76 and the threaded shank 96, induced by thermal expansion and contraction cycling of the showerhead 74 and confine ring 76 during processing, are incapable of inadvertently falling into the chamber interior 72 and contaminating a wafer 80 being processed therein.

While the preferred embodiments of the invention have been described above, it will be recognized and understood that various modifications can be made in the invention and the appended claims are intended to cover all such modifications which may fall within the spirit and scope of the invention.

1. An apparatus comprising:
a process chamber having a chamber wall;
a showerhead provided in said process chamber; and
a plurality of exterior fasteners extending through said chamber wall and into said showerhead.

2. The apparatus of claim 1 wherein each of said plurality of exterior fasteners comprises a fastener head and a threaded shank extending from said fastener head, and wherein said fastener head engages an exterior surface of said chamber wall.

3. The apparatus of claim 1 further comprising a gas mix plate carried by said chamber wall above said showerhead.

4. The apparatus of claim 3 wherein each of said plurality of exterior fasteners comprises a fastener head and a threaded shank extending from said fastener head, and wherein said fastener head engages an exterior surface of said chamber wall.

5. The apparatus of claim 1 further comprising a confine ring provided in said process chamber beneath said showerhead.

6. The apparatus of claim 5 wherein each of said plurality of exterior fasteners comprises a fastener head and a threaded shank extending from said fastener head, and wherein said fastener head engages an exterior surface of said chamber wall.

7. The apparatus of claim 5 further comprising a gas mix plate carried by said chamber wall above said showerhead.

8. The apparatus of claim 7 wherein each of said plurality of exterior fasteners comprises a fastener head and a threaded shank extending from said fastener head, and wherein said fastener head engages an exterior surface of said chamber wall.

9. An apparatus comprising:
a process chamber having a chamber wall;
a showerhead provided in said process chamber;
a confine ring provided in said process chamber beneath said showerhead; and
a plurality of embedded fasteners extending through said confine ring and said showerhead and into said process chamber, with each of said plurality of embedded fasteners substantially embedded in said confine ring.

10. The apparatus of claim 9 wherein each of said plurality of embedded fasteners comprises a fastener head and a threaded shank extending from said fastener head, and wherein said fastener head is substantially flush with said bottom surface of said confine ring.

11. The apparatus of claim 9 wherein said process chamber comprises a gas mix plate carried by said chamber wall above said showerhead and wherein said plurality of embedded fasteners is threaded into said gas mix plate.

12. The apparatus of claim 11 wherein each of said plurality of embedded fasteners comprises a fastener head and a threaded shank extending from said fastener head, and wherein said fastener head is substantially flush with said bottom surface of said confine ring.

13. A method of mounting a showerhead in a process chamber having a chamber wall defining a chamber interior, comprising the steps of:
extending a plurality of fasteners into engagement with the showerhead and the process chamber; and
structurally isolating said plurality of fasteners from the chamber interior.

14. The method of claim 13 wherein said extending a plurality of fasteners into engagement with the showerhead and the process chamber comprises the step of extending a plurality of exterior fasteners inwardly through the chamber wall and into the showerhead.

15. The method of claim 13 wherein each of said plurality of fasteners comprises a fastener head and a threaded shank extending from said fastener head.

16. The method of claim 15 wherein said extending a plurality of fasteners into engagement with the showerhead and the process chamber comprises the step of extending a plurality of exterior fasteners inwardly through the chamber wall and into the showerhead.

17. The method of claim 13 wherein said extending a plurality of fasteners into engagement with the showerhead and the process chamber comprises the step of extending a plurality of embedded fasteners through the showerhead and threading said plurality of embedded fasteners into the process chamber.

18. The method of claim 17 wherein each of said plurality of fasteners comprises a fastener head and a threaded shank extending from said fastener head.

19. The method of claim 14 wherein said structurally isolating said plurality of fasteners from the chamber interior comprises the step of abutting the showerhead against the chamber wall.

20. The method of claim 17 wherein said structurally isolating said plurality of fasteners from the chamber interior comprises the step of embedding said plurality of embedded fasteners in a confine ring disposed in the chamber interior beneath the showerhead.
